(19) United States
(12) Patent Application Publication
(10) Pub. No.: US 2026/0019300 A1
(43) Pub. Date: Jan. 15, 2026

(54) TRANSMISSION APPARATUS, TRANSMISSION SYSTEM, AND TRANSMISSION METHOD

(71) Applicant: Mitsubishi Electric Corporation, Chiyoda-ku, Tokyo (JP)

(72) Inventors: Takahiro ITO, Tokyo (JP); Motonobu JUTORI, Tokyo (JP); Reiko SHIMOZAWA, Tokyo (JP)

(73) Assignee: Mitsubishi Electric Corporation, Chiyoda-ku, Tokyo (JP)

(21) Appl. No.: 18/994,653

(22) PCT Filed: Oct. 18, 2022
(86) PCT No.: PCT/JP2022/038660

§ 371 Date: Jan. 15, 2025

(51) Int. Cl. H04L 12/437; H04L 12/40; H04L 12/46

(52) U.S. Cl. CPC H04L 12/437; H04L 12/40039; H04L 12/4641; H04L 2012/5648

(57) ABSTRACT

A transmission apparatus includes: a first transmission unit having a first port and a second port, the first transmission unit determines whether a packet acquired from one of the ports is output from the other port or output to a connected device; a second transmission unit having a third port and a fourth port, the second transmission unit determines whether a packet acquired from one of the ports is output from the other port or output to the connected device; a bypass control unit provides bypasses between the ports of the first transmission unit and between the ports of the second transmission unit when power-off failures occur in the first and second transmission units; and a packet control unit that controls output of packets acquired by the first and second transmission units when the bypass control is performed in an adjacently connected transmission apparatus.

### FIELD

The present disclosure relates to a transmission apparatus, a transmission system, and a transmission method for use in a train.

### BACKGROUND

Trains conventionally have networks formed across a plurality of cars thereof so as to control devices, etc. installed on each car by communications therewith. For the network formed by a single transmission line, a failure at any single point on the transmission line will cause disconnection of the network, so that the train cannot control the devices. In order to address such a problem, Patent Literature 1 discloses a technique that provides a redundant network including a plurality of transmission repeaters designed to bypass a trunk transmission path when some transmission repeater fails, such that a packet in the trunk transmission path passes past the failed transmission repeater.

### CITATION LIST

### Patent Literature

Patent Literature 1: Japanese Patent Application Laid-open No. 2006-117024

### SUMMARY OF INVENTION

### Problem to be Solved by the Invention

For the above-described conventional technique, the failed transmission repeater allows the passage all packets in the trunk transmission path. This means that the failed transmission repeater, which allows the passage of even a packet addressed to a device connected thereto, cannot take in such a packet. Thus, a problem with the above-described conventional technique is that the packet addressed to the device connected to the failed transmission repeater flows to the network, which may cause congestion, a communication error, etc. in the network.

The present disclosure has been made in view of the above, and an object of the present disclosure is to obtain a transmission apparatus capable of improving redundancy in a transmission system including a plurality of the transmission apparatuses.

### Means to Solve the Problem

To solve the above problem and achieve the object, the present disclosure provides a transmission apparatus in a transmission system including a plurality of transmission apparatuses forming a redundant ring-shaped network. The transmission apparatus comprising: a first transmission unit having a first port and a second port, the first transmission unit performing control as to whether a packet acquired from one of the ports is output from the other port or output to a connected device; a second transmission unit having a third port and a fourth port, the second transmission unit performing control as to whether a packet acquired from one of the ports is output from the other port or output to the connected device; a bypass control unit to perform bypass control to provide bypasses between the ports of the first transmission unit and between the ports of the second transmission unit when power-off failures occur in the first transmission unit and the second transmission unit; and a packet control unit to control output of packets acquired by the first transmission unit and the second transmission unit in a case where the bypass control is being performed in an adjacent transmission apparatus connected via the first port and the third port or via the second port and the fourth port.

### Effects of the Invention

The transmission apparatus of the present disclosure has the effect of improving the redundancy in the transmission system including the plurality of the transmission apparatuses.

### BRIEF DESCRIPTION OF DRAWINGS

FIG. 1 is a diagram illustrating an exemplary configuration of a transmission system according to a first embodiment.

FIG. 2 is a diagram illustrating, as a comparative example, an exemplary transmission system including transmission apparatuses that each have two ports and relay packets.

FIG. 3 is a diagram illustrating the transmission system according to the first embodiment illustrated in FIG. 1, which has been simplified in accordance with the transmission system of the comparative example given in FIG. 2.

FIG. 4 is a block diagram illustrating an exemplary configuration of a transmission apparatus according to the first embodiment.

FIG. 5 is a first diagram showing an example in which a transmission apparatus performs alive monitoring in the transmission system according to the first embodiment.

FIG. 6 is a second diagram showing the example in which the transmission apparatus performs alive monitoring in the transmission system according to the first embodiment.

FIG. 7 is a diagram illustrating a transmission apparatus performing bypass control in the transmission system according to the first embodiment.

FIG. 8 is a flowchart illustrating operation in which the transmission apparatus according to the first embodiment performs bypass control.

FIG. 9 is a flowchart illustrating operation in which the transmission apparatus according to the first embodiment performs packet control.

FIG. 10 is a diagram illustrating an exemplary configuration of processing circuitry of the transmission apparatus according to the first embodiment, the processing circuitry being implemented by a processor and a memory.

FIG. 11 is a diagram illustrating an exemplary configuration of processing circuitry of the transmission apparatus according to the first embodiment, the processing circuitry being implemented by dedicated hardware.

FIG. 12 is a block diagram illustrating an exemplary configuration of a transmission apparatus according to a third embodiment.

### DESCRIPTION OF EMBODIMENTS

Transmission apparatuses, transmission systems, and transmission methods according to embodiments of the present disclosure will be hereinafter described in detail with reference to the drawings.

### First Embodiment

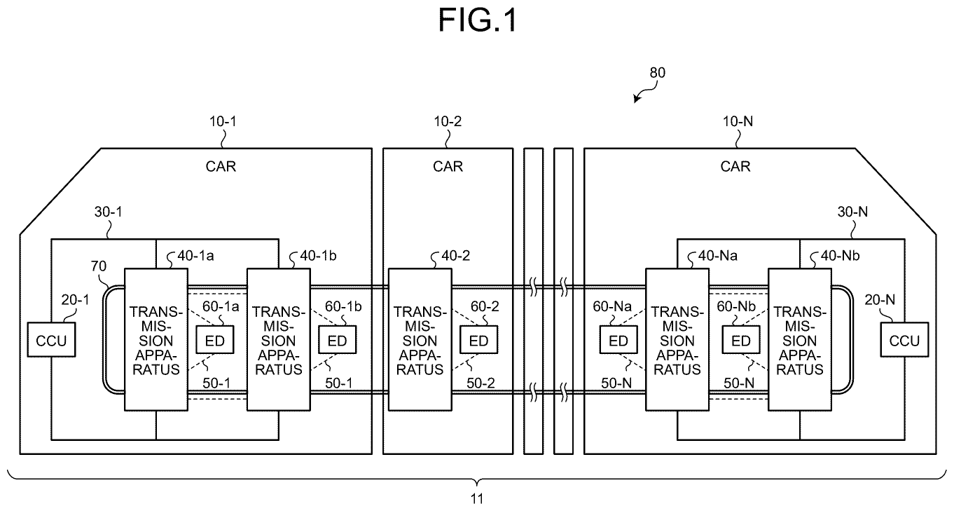

FIG. 1 is a diagram illustrating an exemplary configuration of a transmission system 80 according to a first embodiment. The transmission system 80 is a system to be installed on a train 11 defined by a plurality of cars 10-1, 10-2, . . . , and 10-N. In the following description, the cars 10-1, 10-2, . . . , and 10-N may be collectively referred to as cars 10 when not distinguished from each other. In the example of FIG. 1, the train 11 includes N cars 10. Note that N is an integer equal to or greater than 2. For the sake of convenience, the following description assumes that the car 10-1 is a first car, and that the car 10-N is a last car. However, the car 10-1 may be defined as a last car, and the car 10-N may be defined as a first car.

The transmission system 80 includes transmission apparatuses 40-1a, 40-1b, 40-2, . . . , 40-Na, and 40-Nb and a train bus 70. The transmission system 80 is a system in which the transmission apparatuses 40-1a, 40-1b, 40-2, . . . , 40-Na, and 40-Nb are connected by the train bus 70 to form a redundant ring-shaped network. The assumption is that when the transmission system 80 is normal, for example, a packet generated by a central control unit (CCU) 20-1 or a CCU 20-N is transmitted clockwise through the train bus 70. The train bus 70 performs communication by utilizing, for example, 100BASE-TX, that is, Ethernet (registered trademark).

The transmission apparatus 40-1a is connected to an end device (ED) 60-1a through a car bus 50-1, the transmission apparatus 40-1b is connected to an ED 60-1b through the car bus 50-1, the transmission apparatus 40-2 is connected to an ED 60-2 through a car bus 50-2, . . . , the transmission apparatus 40-Na is connected to an ED 60-Na through a car bus 50-N, and the transmission apparatus 40-Nb is connected to an ED 60-Nb through the car bus 50-N. In addition, the transmission apparatus 40-1a and the transmission apparatus 40-1b at the first car, or the car 10-1, are connected to each other through the train bus 70 and the car bus 50-1. The transmission apparatus 40-Na and the transmission apparatus 40-Nb at the last car, or the car 10-N, are connected to each other through the train bus 70 and the car bus 50-N.

In the following description, the transmission apparatuses 40-1a, 40-1b, 40-2, . . . , 40-Na, and 40-Nb may be collectively referred to as transmission apparatuses 40 when not distinguished from each other. In addition, the car buses 50-1, 50-2, . . . , and 50-N may be collectively referred to as car buses 50 when not distinguished from each other. Furthermore, the EDs 60-1a, 60-1b, 60-2, . . . , 60-Na, and 60-Nb may be collectively referred to as EDs 60 when not distinguished from each other. For example, a virtual local area network (VLAN) is set for the car buses 50 and the train bus 70 through which packets are transmitted and received between the transmission apparatuses 40.

In the example of FIG. 1, a single ED 60 is connected to each transmission apparatus 40, but the configuration of the transmission system 80 according to the present embodiment is not limited thereto. Two or more EDs 60, that is, a plurality of EDs 60 may be connected to each of the transmission apparatuses 40. Examples of the ED 60 include, but not be limited to, a brake, an air conditioner, and a door. In the example of FIG. 1, the car 10-1, which is the first car, and the car 10-N, which is the last car, each include two transmission apparatuses 40, and middle cars including the car 10-2 each include a single transmission apparatus 40, but the configuration of the transmission system 80 according to the present embodiment is not limited thereto. In general, among the cars 10 included in the train 11, the car 10-1, which is the first car, and the car 10-N, which is the last car, have the greater number of EDs 60 installed thereon than a middle car such as the car 10-2. For this reason, in the example of FIG. 1, the car 10-1, which is the first car, and the car 10-N, which is the last car, each include two transmission apparatuses 40 for the purpose of reducing a burden of monitoring the ED 60 of each transmission apparatus 40.

The car 10-1, which is the first car, includes the CCU 20-1. The CCU 20-1 is connected to the transmission apparatuses 40-1a and 40-1b via a train bus 30-1. In addition, the car 10-N, which is the last car, includes the CCU 20-N. The CCU 20-N is connected to the transmission apparatuses 40-Na and 40-Nb via a train bus 30-N. The CCUs 20-1 and 20-N have the same configuration, and one of the CCUs 20-1 and 20-N just needs to operate on the train 11. A description below will be made as to the operation of the CCU 20-1. In the following description, the CCUs 20-1 and 20-N may be collectively referred to as CCUs 20 when not distinguished from each other. In addition, the train buses 30-1 and 30-N may be collectively referred to as train buses 30 when not distinguished from each other. The train buses 30 perform communication by, utilizing, for example, 100BASE-TX, that is, Ethernet.

The CCU 20-1 controls operation of the EDs 60, etc. installed on the train 11. When controlling the operation of a certain ED 60, the CCU 20-1 generates a packet addressed to a control target ED 60, and outputs the generated packet to the transmission apparatuses 40-1a and 40-1b via the train bus 30-1. The car 10-1 provides redundancy as the car 10-1 includes the transmission apparatuses 40-1a and 40-1b, i.e., the two transmission apparatuses 40 that are destinations of the packet output from the CCU 20-1. For example, in a case where a packet acquired from the CCU 20-1 is addressed to the ED 60-Na, the transmission apparatus 40-1b outputs the acquired packet to the transmission apparatus 40-2 of the adjacent car 10-2. The transmission apparatus 40-1a outputs an acquired packet to the adjacent transmission apparatus 40-1b. When the packet which the transmission apparatus 40-1b acquired from the transmission apparatus 40-1a is the same as the already acquired packet, the transmission apparatus 40-1b discards the packet acquired from the transmission apparatus 40-1a instead of outputting the packet to the transmission apparatus 40-2 of the adjacent car 10-2. Furthermore, in a case where a packet acquired from the CCU 20-1 is addressed to the ED 60-1b, the transmission apparatus 40-1b does not output the acquired packet to the transmission apparatus 40-2 of the adjacent car 10-2, but outputs the packet to the ED 60-1b via the car bus 50-1.

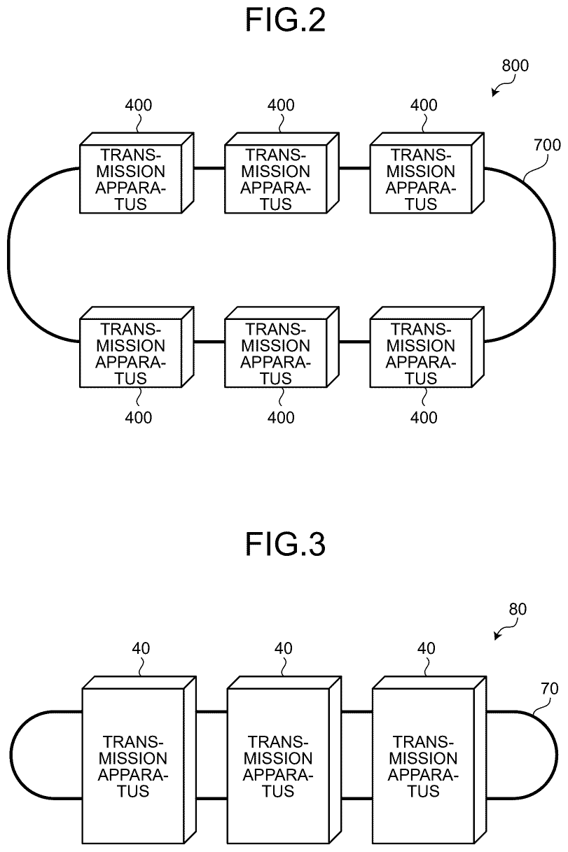

In the first embodiment, the transmission apparatus 40 functions as two general transmission apparatuses corresponding to the transmission repeater described in the above-described related art literature. FIG. 2 is a diagram illustrating, as a comparative example, an exemplary transmission system 800 including transmission apparatuses 400 that each have two ports and relay packets. In the transmission system 800 of the comparative example, each transmission apparatus 400 is connected at its two ports to a train bus 700. In the transmission system 800 of the comparative example, even when one of the transmission apparatuses 400 fails, the remaining transmission apparatuses 400 can continue communication via the train bus 700.

FIG. 3 is a diagram illustrating the transmission system 80 according to the first embodiment illustrated in FIG. 1, in simple form corresponding to the transmission system 800 of the comparative example given in FIG. 2. In the transmission system 80, each transmission apparatus 40 is connected at its four ports to the train bus 70. When it comes to a general transmission function, the transmission apparatus 40 functions as the two transmission apparatuses 400 illustrated in FIG. 2. In the transmission system 80, for example, when the transmission apparatus 40 located in the center of FIG. 3 fails and is unable to relay packets, the remaining transmission apparatuses 40 become unable to continue communication via the train bus 70. To address this, the transmission apparatus 40 of the first embodiment provides a bypass between the ports at the time of a power-off failure, thereby outputting a packet acquired from one of the transmission apparatuses 40 to the other transmission apparatus 40.

The transmission apparatus 40 in a power-off failure outputs all packets via the bypass, including a packet addressed to the ED 60 connected to that transmission apparatus 40 itself. In this case, the packet addressed to the ED 60 connected to the transmission apparatus 40 in the power-off failure continues to flow through the train bus 70 unless another transmission apparatus 40 takes measures such as taking in or discarding the packet. To address this, in the first embodiment, the transmission apparatus 40 adjacent to the transmission apparatus 40 in the power-off failure performs control in such a way as to discard the packet addressed to the ED 60 connected to the transmission apparatus 40 in the power-off failure.

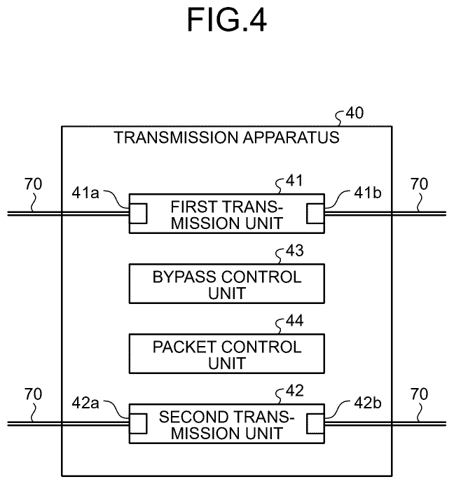

The configuration and operation of the transmission apparatus 40 will be described in detail. FIG. 4 is a block diagram illustrating an exemplary configuration of the transmission apparatus 40 according to the first embodiment. The transmission apparatus 40 includes a first transmission unit 41, a second transmission unit 42, a bypass control unit 43, and a packet control unit 44.

The first transmission unit 41 has a first port 41a and a second port 41b. The first transmission unit 41 performs control as to whether a packet acquired from one of the ports is output from the other port or output to the ED 60 which is a connected device. That is, during the normal operation of the transmission apparatus 40, the first transmission unit 41 takes in a packet acquired from one of the ports and outputs the acquired packet to the connected ED 60 when the packet is addressed to the connected ED 60; the first transmission unit 41 outputs the acquired packet from the other port when the acquired packet is not addressed to the connected ED 60. The first transmission unit 41 in a normal operation state operates in the same manner as a single transmission apparatus 400 illustrated in FIG. 2.

The second transmission unit 42 has a third port 42a and a fourth port 42b. The second transmission unit 42 performs control as to whether a packet acquired from one of the ports is output from the other port or output to the ED 60 which is the connected device. That is, during the normal operation of the transmission apparatus 40, the second transmission unit 42 takes in a packet acquired from one of the ports and outputs the acquired packet to the connected ED 60 when the packet is addressed to the connected ED 60; the second transmission unit 42 outputs the acquired packet from the other port when the acquired packet is not addressed to the connected ED 60. The second transmission unit 42 in a normal operation state operates in the same manner as a single transmission apparatus 400 illustrated in FIG. 2.

The bypass control unit 43 performs bypass control to provide bypasses between the ports of the first transmission unit 41 and between the ports of the second transmission unit 42 when power-off failures occur in the first transmission unit 41 and the second transmission unit 42. Specifically, when power-off failures occur in the first transmission unit 41 and the second transmission unit 42, the bypass control unit 43 performs the above-described bypass control such that the bypass control unit 43 bypasses the first port 41a and the second port 41b in the first transmission unit 41 to allow a packet acquired from one of the ports to be output from the other port, and bypasses the third port 42a and the fourth port 42b in the second transmission unit 42 to allow a packet acquired from one of the ports to be output from the other port.

The bypass control unit 43 has a function of turning on a b-contact in the first transmission unit 41 and a function of turning on a b-contact in the second transmission unit 42 when power-off failures occur in the first transmission unit 41 and the second transmission unit 42. Thus, the transmission apparatus 40 may include two bypass control units 43, that is, the bypass control unit 43 intended for the first transmission unit 41 and the bypass control unit 43 intended for the second transmission unit 42. In a case where the transmission apparatus 40 includes the two bypass control units 43, the two bypass control units 43 may cooperate with each other by such a method as periodically performing communication therebetween, and perform bypass control only when power-off failures occur both in the first transmission unit 41 and the second transmission unit 42. Note that when a power-off failure occurs in only one of the first transmission unit 41 and the second transmission unit 42 while the other transmission unit normally operates, the bypass control unit 43 may optionally perform the bypass control on the transmission unit in the power-off failure.

The packet control unit 44 controls the output of packets acquired by the first transmission unit 41 and the second transmission unit 42 when the adjacent transmission apparatus 40 connected via the first port 41a and the third port 42a or via the second port 41b and the fourth port 42b performs the bypass control. Consider the transmission apparatus 40-1b illustrated in FIG. 1 by way of example. In this case, the adjacent transmission apparatus 40 connected to the transmission apparatus 40-1b via the first port 41a and the third port 42a of the transmission apparatus 40-1b is the transmission apparatus 40-1a; the adjacent transmission apparatus 40 connected to the transmission apparatus 40-1b via the second port 41b and the fourth port 42b of the transmission apparatus 40-1b is the transmission apparatus 40-2. The packet control unit 44 discards a packet acquired by at least one of the first transmission unit 41 and the second transmission unit 42 during the bypass control in the adjacent transmission in a case where the packet is addressed to the ED 60 which is a device connected to the adjacent transmission apparatus 40.

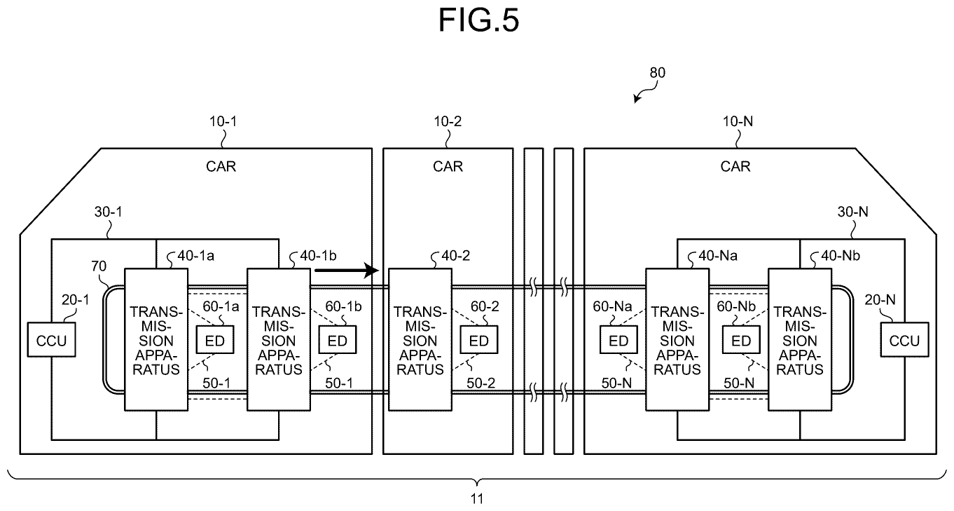

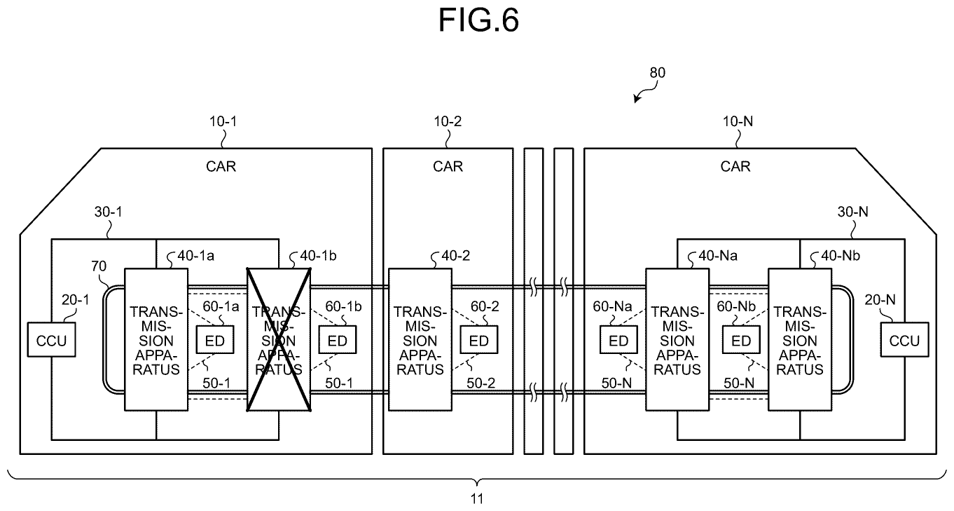

A specific description will be given of a case where with a power-off failure occurring in the transmission apparatus 40-1b in the transmission system 80, the transmission apparatus 40-1b performs bypass control and the transmission apparatus 40-2 performs packet control. FIG. 5 is a first diagram showing an example in which the transmission apparatus 40 performs alive monitoring in the transmission system 80 according to the first embodiment. FIG. 5 shows a situation in which the transmission apparatus 40-1b periodically transmits a hello packet to the transmission apparatus 40-2. Note that although not illustrated in FIG. 5, a hello packet is transmitted and received also between the other transmission apparatuses 40. When periodically receiving a hello packet from the transmission apparatus 40-1b, the transmission apparatus 40-2 determines that the FIG. 6 transmission apparatus 40-1b is normally operating. is a second diagram showing the example in which the transmission apparatus 40 performs alive monitoring in the transmission system 80 according to the first embodiment. As the transmission apparatus 40-2 receives no hello packet from the transmission apparatus 40-1b, the transmission apparatus 40-2 determines that the transmission apparatus 40-1b is not operating normally. That is, when receiving no hello packet periodically transmitted from the adjacent transmission apparatus 40, the packet control unit 44 determines that power-off failures have occurred in the first transmission unit 41 and the second transmission unit 42 of the adjacent transmission apparatus 40, and that bypass control is being performed in the adjacent transmission apparatus 40.

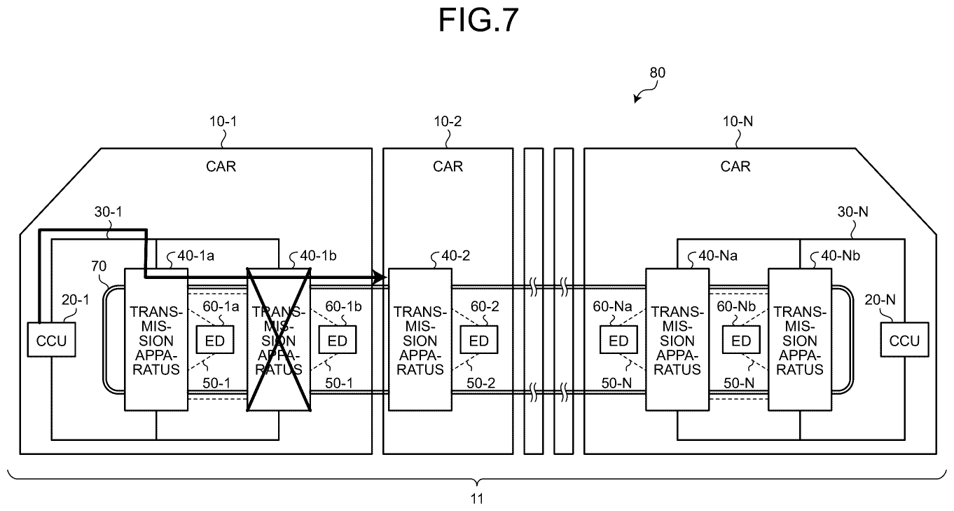

FIG. 7 is a diagram illustrating the transmission apparatus 40-1b performing bypass control in the transmission system 80 according to the first embodiment. Under the control of the bypass control unit 43, the transmission apparatus 40-1b bypasses a packet acquired from the transmission apparatus 40-1a, and outputs the packet to the transmission apparatus 40-2. In this case, the transmission apparatus 40-1b bypasses even a packet addressed to the ED 60-1b, and outputs the packet to the transmission apparatus 40-2. To address this, the transmission apparatus 40-2, which has determined that the transmission apparatus 40-1b is not operating normally, discards a packet acquired from the transmission apparatus 40-1b when the packet is addressed to the ED 60-1b connected to the transmission apparatus 40-1b. With the transmission apparatus 40-2, a packet addressed to the ED 60-1b, which is a packet unnecessary for the transmission apparatus 40 at a subsequent stage, does not flow to the subsequent transmission apparatus 40.

The packet control unit 44 of the transmission apparatus 40-2 includes, for example, two VLAN tables. Depending on whether the adjacent transmission apparatus 40-1b is normally operating, the packet control unit 44 of the transmission apparatus 40-2 switches between the VLAN tables, and performs control as to whether to output an acquired packet to the subsequent transmission apparatus 40, output the acquired packet to the ED 60-2, or discard the acquired packet. Specifically, when the transmission apparatus 40-1b normally operates, the packet control unit 44 of the transmission apparatus 40-2 uses a VLAN table stipulating that: a packet addressed to the ED 60 connected to a transmission apparatus 40 at a subsequent stage is output to a next transmission apparatus 40-3 (not illustrated); and a packet addressed to the ED 60-2 is output to the ED 60-2. When the transmission apparatus 40-1b does not normally operates, the packet control unit 44 of the transmission apparatus 40-2 uses a VLAN table stipulating that: a packet addressed to the ED 60 connected to the transmission apparatus 40 at the subsequent stage is output to the next transmission apparatus 40-3 (not illustrated); a packet addressed to the ED 60-2 is output to the ED 60-2; and a packet addressed to the ED 60-1b is discarded.

Note that, in the transmission system 80, it is also conceivable that power-off failures may occur in a plurality of transmission apparatuses 40. Therefore, the packet control unit 44 of the transmission apparatus 40 may hold a VLAN table stipulating that not only a packet addressed to the ED 60 connected to the adjacent transmission apparatus 40 but also packets addressed to the EDs 60 connected to a plurality of transmission apparatuses 40 on an upstream side where the CCU 20 is located as a packet transmission source are discarded. Note that VLAN tables of the packet control unit 44 of the transmission apparatus 40 may be set by an installer or the like of the transmission system 80, but may be set by another person.

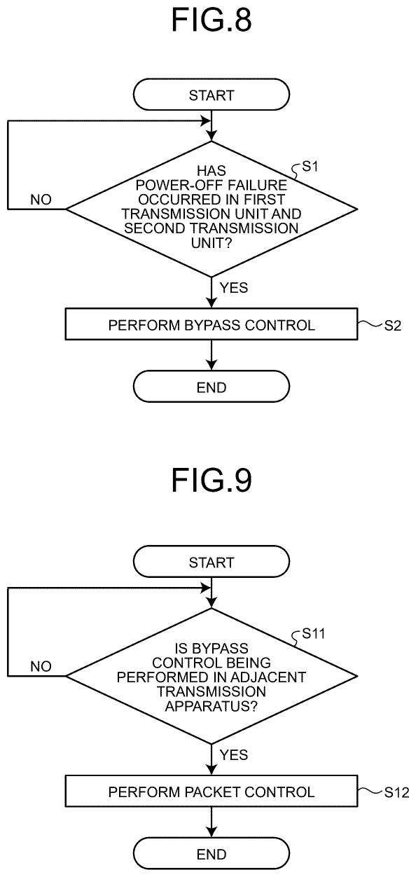

Operation of the transmission apparatus 40 will be described with reference to flowcharts. FIG. 8 is a flowchart illustrating operation in which the transmission apparatus 40 according to the first embodiment performs bypass control. In the transmission apparatus 40, the bypass control unit 43 determines whether power-off failures have occurred in the first transmission unit 41 and the second transmission unit 42 (step S1). For example, by periodically communicating with the first transmission unit 41 and the second transmission unit 42, the bypass control unit 43 may determine whether the power-off failures have occurred in the first transmission unit 41 and the second transmission unit 42. Alternatively, by checking whether the first transmission unit 41 and the second transmission unit 42 are periodically transmitting hello packets, the bypass control unit 43 may determine whether the power-off failures have occurred in the first transmission unit 41 and the second transmission unit 42. When no power-off failure has occurred in the first transmission unit 41 and the second transmission unit 42 (step S1: No), the bypass control unit 43 continues to determine whether power-off failures have occurred in the first transmission unit 41 and the second transmission unit 42 (step S1). When the power-off failures have occurred in the first transmission unit 41 and the second transmission unit 42 (step S1: Yes), the bypass control unit 43 performs the bypass control as described above (step S2).

FIG. 9 is a flowchart illustrating operation in which the transmission apparatus 40 according to the first embodiment performs packet control. In the transmission apparatus 40, the packet control unit 44 determines whether the bypass control is being performed in the adjacent transmission apparatus 40 (step S11). As described above, depending upon whether the transmission apparatus 40 receives a hello packet from the adjacent transmission apparatus 40, the packet control unit 44 can determine whether the bypass control is being performed in the adjacent transmission apparatus 40. When the bypass control is not being performed in the adjacent transmission apparatus 40 (step S11: No), the packet control unit 44 continues to determine whether the bypass control is being performed in the adjacent transmission apparatus 40 (step S11). When the bypass control is being performed in the adjacent transmission apparatus 40 (step S11: Yes), the packet control unit 44 performs the above-described packet control to discard a packet addressed to the ED 60 connected to the adjacent transmission apparatus 40 (step S12).

Next, a hardware configuration of the transmission apparatus 40 according to the first embodiment will be described. In the transmission apparatus 40, the first transmission unit 41, the second transmission unit 42, the bypass control unit 43, and the packet control unit 44 are implemented by processing circuitry. The processing circuitry may be a memory that stores programs, and a processor that executes the programs stored in the memory. Alternatively, the processing circuitry may be dedicated hardware. The processing circuitry is also referred to as a control circuit.

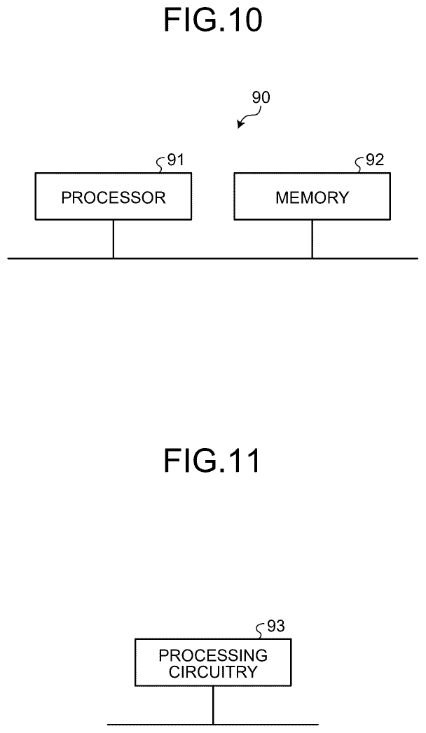

FIG. 10 is a diagram illustrating an exemplary configuration of processing circuitry 90 of the transmission apparatus 40 according to the first embodiment, the processing circuitry 90 being implemented by a processor 91 and a memory 92. The processing circuitry 90 illustrated in FIG. 10 is a control circuit, and includes the processor 91 and the memory 92. In a case where the processing circuitry 90 includes the processor 91 and the memory 92, each function of the processing circuitry 90 is implemented by software, firmware, or a combination of software and firmware. The software or firmware is described as a program and stored in the memory 92. In the processing circuitry 90, the processor 91 reads and executes the program stored in the memory 92 to implement each function. That is, the processing circuitry 90 includes the memory 92 for storing the program. As a result of execution of the program, the transmission apparatus 40 is caused to perform processing. It can also be said that this program is a program for causing the transmission apparatus 40 to execute each function to be implemented by the processing circuitry 90. This program may be provided by means of a storage medium in which the program has been stored, or may be provided by other means such as a communication medium.

It can also be said that the program described above is a program for causing the transmission apparatus 40 to perform: a first step in which the first transmission unit 41 having the first port 41a and the second port 41b performs control as to whether a packet acquired from one of the ports is output from the other port or output to the ED 60 which is a connected device; a second step in which the second transmission unit 42 having the third port 42a and the fourth port 42b performs control as to whether a packet acquired from one of the ports is output from the other port or output to the ED 60 which is the connected device; a third step in which the bypass control unit 43 performs bypass control to provide bypasses between the ports of the first transmission unit 41 and between the ports of the second transmission unit 42 when power-off failures occur in the first transmission unit 41 and the second transmission unit 42; and a fourth step in which the packet control unit 44 controls output of packets acquired by the first transmission unit 41 and the second transmission unit 42, in a case where the bypass control is being performed in the adjacent transmission apparatus 40 connected via the first port 41a and the third port 42a or via the second port 41b and the fourth port 42b.

Here, the processor 91 is, for example, a central processing unit (CPU), a processing device, an arithmetic device, a microprocessor, a microcomputer, or a digital signal processor (DSP). Furthermore, examples of the memory 92 include nonvolatile or volatile semiconductor memories such as a random access memory (RAM), a read only memory (ROM), a flash memory, an erasable programmable ROM (EPROM), and an electrically EPROM (EEPROM (registered trademark)), a magnetic disk, a flexible disk, an optical disk, a compact disk, a mini disk, and a digital versatile disc (DVD).

FIG. 11 is a diagram illustrating an exemplary configuration of processing circuitry 93 of the transmission apparatus 40 according to the first embodiment, the processing circuitry 93 being implemented by dedicated hardware. The processing circuitry 93 illustrated in FIG. 11 corresponds to, for example, a single circuit, a composite circuit, a programmed processor, a parallel-programmed processor, an application specific integrated circuit (ASIC), a field-programmable gate array (FPGA), or a combination thereof. A part of the processing circuitry 93 may be implemented by dedicated hardware, and another part of the processing circuitry 93 may be implemented by software or firmware. Thus, the processing circuitry 93 can implement each of the above-described functions by means of dedicated hardware, software, firmware, or a combination thereof.

As described above, in the transmission apparatus 40 according to the present embodiment, the bypass control unit 43 performs bypass control to provide bypasses between the ports of the first transmission unit 41 and between the ports of the second transmission unit 42 when power-off failures occur in the first transmission unit 41 and the second transmission unit 42. In addition, when the bypass control is being performed in the adjacent transmission apparatus 40, the packet control unit 44 performs packet control to discard a packet addressed to the ED 60 connected to the adjacent transmission apparatus 40. As a result, the transmission apparatus 40 can continue communication in the transmission system 80 even when the power-off failure occurs in any of the transmission apparatuses 40 in the transmission system 80. The transmission apparatus 40 can improve redundancy in the transmission system 80 including the plurality of transmission apparatuses 40.

In addition, since it is possible to reduce the number of transmission apparatuses 40 used in the transmission system 80 as compared with the transmission apparatus 400 as illustrated in FIG. 2, it is possible to improve workability in installing the transmission system 80 on the car 10, and reduce the number of maintenance target devices regularly inspected, as well.

### Second Embodiment

In the first embodiment, when the bypass control is performed in the adjacent transmission apparatus 40 because of the power-off failures of the first transmission unit 41 and the second transmission unit 42, the transmission apparatus 40 performs packet control to discard a packet addressed to the ED 60 connected to the adjacent transmission apparatus 40. In this case, the CCU 20, which is a transmission source of packets, does not recognize the existence of the transmission apparatus 40 performing the bypass control. For this reason, the CCU 20 continues outputting packets addressed to the ED 60 connected to the transmission apparatus 40 performing the bypass control.

To address this, the transmission apparatus 40 performing the packet control may instruct the CCU 20 to stop the transmission of packets addressed to the ED 60 connected to the adjacent transmission apparatus 40 performing the bypass control. That is, in the transmission apparatus 40 performing packet control to discard a packet transmitted from a transmission source apparatus, the packet control unit 44 instructs the transmission source apparatus to stop transmitting packets addressed to the same destination as the discarded packet.

As a result, the transmission apparatus 40 performing the packet control receives no packets addressed to the ED 60 connected to the adjacent transmission apparatus 40 performing the bypass control. The transmission apparatus 40 performing the packet control can thus reduce a processing load for discarding the packets.

### Third Embodiment

In the first embodiment, the transmission apparatus 40 includes the bypass control unit 43 separately from the first transmission unit 41 and the second transmission unit 42. Meanwhile, the first transmission unit 41 and the second transmission unit 42 may have the function of the bypass control unit 43.

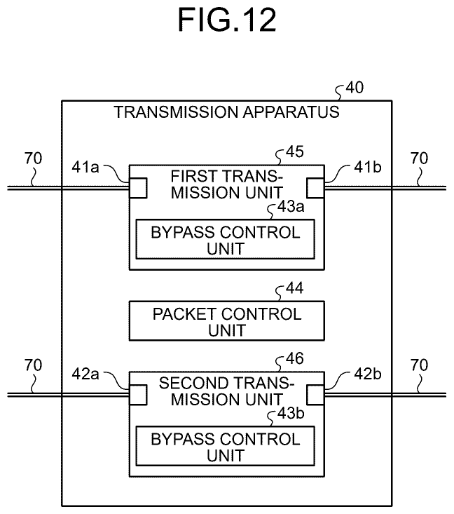

FIG. 12 is a block diagram illustrating an exemplary configuration of the transmission apparatus 40 according to a third embodiment. The transmission apparatus 40 includes a first transmission unit 45, a second transmission unit 46, and the packet control unit 44. The first transmission unit 45 includes a bypass control unit 43a. Similarly, the second transmission unit 46 includes a bypass control unit 43b. In the transmission apparatus 40 illustrated in FIG. 12, the bypass control unit 43a included in the first transmission unit 45 and the bypass control unit 43b of the second transmission unit 46 have the same function as the bypass control unit 43 of the first embodiment.

In the third embodiment, when the power-off failure occurs in the first transmission unit 45, the bypass control unit 43a of the first transmission unit 45 may perform bypass control such that the bypass control unit 43a bypasses the first port 41a and the second port 41b in the first transmission unit 45, thereby allowing a packet acquired from one of the ports to be output from the other port. Similarly, when the power-off failure occurs in the second transmission unit 46, the bypass control unit 43b of the second transmission unit 46 may perform bypass control such that the bypass control unit 43b bypasses the third port 42a and the fourth port 42b in the second transmission unit 46, thereby allowing a packet acquired from one of the ports to be output from the other port. The transmission apparatus 40 may be configured such that the bypass control unit 43a of the first transmission unit 45 and the bypass control unit 43b of the second transmission unit 46 cooperate with each other by such a method as periodically performing communication therebetween, and perform the same bypass control as that in the first embodiment only when power-off failures occur both in the first transmission unit 45 and the second transmission unit 46. Note that when the power-off failure occurs in only one of the first transmission unit 45 and the second transmission unit 46 while the other transmission unit normally operates, the bypass control units 43a and 43b may optionally perform bypass control on the transmission unit in the power-off failure. Also in this case, the transmission apparatus 40 can obtain the same effect as in the first embodiment.

The configurations set forth in the above embodiments show examples, and it is possible to combine the configurations with another known technique or combine the embodiments with each other, and is also possible to partially omit or change the configurations without departing from the scope of the present disclosure.

### REFERENCE SIGNS LIST

10, 10-1, 10-2 to 10-N car; 11 train; 20-1, 20-N CCU; 30-1, 30-N, 70, 700 train bus; 40, 40-1a, 40-1b, 40-2 to 40-Na, 40-Nb, 400 transmission apparatus; 41, 45 first transmission unit; 41a first port; 41b second port; 42, 46 second transmission unit; 42a third port; 42b fourth port; 43, 43a, 43b bypass control unit; 44 packet control unit; 50-1, 50-2 to 50-N car bus; 60-1a, 60-1b, 60-2 to 60-Na, 60-Nb ED; 80, 800 transmission system; 90, 93 processing circuitry; 91 processor; 92 memory.

1. A transmission apparatus in a transmission system including a plurality of transmission apparatuses forming a redundant ring-shaped network, the transmission apparatus comprising:
first transmission circuitry having a first port and a second port, the first transmission circuitry performing control as to whether a packet acquired from one of the ports is output from the other port or output to a device connected to the transmission apparatus;
second transmission circuitry having a third port and a fourth port, the second transmission circuitry performing control as to whether a packet acquired from one of the ports is output from the other port or output to the device connected to the transmission apparatus;
bypass control circuitry to perform bypass control to provide bypasses between the ports of the first transmission circuitry and between the ports of the second transmission circuitry when power-off failures occur in the first transmission circuitry and the second transmission circuitry; and
packet control circuitry to control output of packets acquired by the first transmission circuitry and the second transmission circuitry; in a case where the bypass control is being performed in an adjacent transmission apparatus connected via the first port and the third port or via the second port and the fourth port.

2. The transmission apparatus according to claim 1, wherein
the packet control circuitry discards a packet acquired by at least one of the first transmission circuitry and the second transmission circuitry during the bypass control in the adjacent transmission apparatus in a case where the acquired packet is addressed to a device connected to the adjacent transmission apparatus.

3. The transmission apparatus according to claim 2, wherein
the packet control circuitry instructs an apparatus to stop transmitting a packet addressed to a same destination as the discarded packet, the apparatus being a transmission source of the discarded packet.

4. The transmission apparatus according to claim 1, wherein
when the transmission apparatus receives no hello packet periodically transmitted from the adjacent transmission apparatus, the packet control circuitry determines that power-off failures have occurred in the first transmission circuitry and the second transmission circuitry of the adjacent transmission apparatus, and that the bypass control is being performed in the adjacent transmission apparatus.

5. The transmission apparatus according to claim 1, wherein
when power-off failures occur in the first transmission circuitry and the second transmission circuitry, the bypass control circuitry performs the bypass control such that the bypass control circuitry bypasses the first port and the second port in the first transmission circuitry to allow a packet acquired from one of the ports to be output from the other port, and bypasses the third port and the fourth port in the second transmission circuitry to allow a packet acquired from one of the ports to be output from the other port.

6. A transmission system comprising a plurality of the transmission apparatuses according to claim 1, wherein a redundant ring-shaped network is formed by the transmission apparatuses.

7. A transmission method to be used by a transmission apparatus in a transmission system including a plurality of transmission apparatuses to forming a redundant ring-shaped network, the transmission method comprising:
performing control as to whether a packet acquired from one of the. first and second ports of first transmission circuitry is output from the other port or output to a device connected to the transmission apparatus;
performing control as to whether a packet acquired from one of third and fourth ports of second transmission circuitry is output from the other port or output to the a device connected to the transmission apparatus;
performing bypass control to provide bypasses between the ports of the first transmission circuitry and between the ports of the second transmission circuitry when power-off failures occur in the first transmission circuitry and the second transmission circuitry; and
controlling output of packets acquired by the first transmission circuitry and the second transmission circuitry in a case where the bypass control is being performed in an adjacent transmission apparatus connected via the first port and the third port or via the second port and the fourth port.

8. The transmission method according to claim 7, wherein
controlling the output of the packets includes discarding a packet acquired by at least one of the first transmission circuitry and the second transmission circuitry during the bypass control in the adjacent transmission apparatus in a case where the acquired packet is addressed to a device connected to the adjacent transmission apparatus.

9. The transmission method according to claim 8, wherein
controlling the output of the packets includes instructing an apparatus to stop transmitting a packet addressed to a same destination as the discarded packet, the apparatus being a transmission source of the discarded packet.

10. The transmission method according to claim 7, wherein
controlling the output of the packets includes determining that power-off failures have occurred in the first transmission circuitry and the second transmission circuitry of the adjacent transmission apparatus, and that the bypass control is being performed in the adjacent transmission apparatus when the transmission apparatus receives no hello packet periodically transmitted from the adjacent transmission apparatus.

11. The transmission method according to claim 7, wherein
performing bypass control includes bypassing the first port and the second port in the first transmission circuitry to allow a packet acquired from one of the ports to be output from the other port, and bypassing the third port and the fourth port in the second transmission circuitry to allow a packet acquired from one of the ports to be output from the other port when power-off failures occur in the first transmission circuitry and the second transmission circuitry.
